(19) United States
(12) Patent Application Publication
(10) Pub. No.: US 2006/0042945 A1
(43) Pub. Date: Mar. 2, 2006

(54) Indicator electrode used for electrochemical measurement of liquid

(76) Inventor: Yoshitaka Ootomo, Fujisawa-Shi (JP)

Correspondence Address: Richard P. Berg;LADAS & PARRY, Suite # 2100, 5670 Wilshire Boulevard, Los Angeles, CA, 90036-5679, US

(21) Appl. No.: 11/182,609

(22) Filed: Jul. 15, 2005

(30) Foreign Application Priority Data
Sep. 1, 2004 (JP) 2004/288628

(51) Int. Cl. G01N 27/26

(52) U.S. Cl. 204/403.01; 204/400

(57) ABSTRACT

The present invention is to provide an indicator electrode allowing accurate and stable measurement of potential not only for system solution containing oxidant s well as reductant at relatively high concentration, but also even for system solution containing oxidant as well as reductant at relatively low concentration and solution of excessively high purity. For the purpose of this object, indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 0.50 or less as measured in accordance with “Center line arithmetic average roughness Ra(μm)” specified by JIS B0601-1994, or 1.70 or less as measured in accordance with “Maximum height Ry(μm)” specified by JIS B0601-1994 or 1.00 or less as measured in accordance with “Ten-point average roughness Rz(μm)” specified by JIS B0601-1994.

### FIELD OF THE INVENTION

The present invention relates to an indicator electrode used for electrochemical measurement of liquid, for example, the indicator electrode of the oxidation-reduction potentiometer.

### BACKGROUND OF THE INVENTION

As a typical example of the electrochemical measuring apparatus having an indicator electrode made of conductive material and adapted to measure potential and current generating at the interface between the indicator and solution, so-called oxidation-reduction potentiometer is well known. The oxidation-reduction potentiometer is provided with the indicator electrode made of conductive material such as metal and a reference electrode and adapted to measure, for example, a concentration of electrolyte in solution and an ion concentration ratio between oxidant and reductant by putting the solution in contact with the indicator electrode. Specifically, when the electrode, for example, made of platinum free from any chemical affection by the solution containing oxidant and reductant is immersed in this solution, the electrode has a potential relative to the solution and comes to equilibrium. This potential is referred to as the oxidation-reduction potential.

Oxidation-reduction reaction is expressed by
Red⇄Ox+ne
where Ox represents oxidant and Red represents reductant.

Oxidation-reduction potential E is given by Nernst's equation as follows:
E=Eo+nF−RT 1n [Red][Ox]
where Eo: Reference oxidation-reduction potential (i.e., E at a moment of [Ox]=[Red] and specific for the system solution)
R: Gas constant
T: absolute temperature
F: Faraday constant
n: the number of electrons participating in reaction
[ ]: Concentration (i.e., activity)

However, the indicator electrode of prior art may often result in a wide range of fluctuations in measured value. For example, when concentration of oxidant and reductant contained in system solution is relatively low or purity of system solution is excessively high, oxidation-reduction potential E may become inconstant and stability of potential measurement may be deteriorated. In other words, even if the same solution is measured more than once under same condition and for substantially same period, the measured value may be inconstant and, in addition, a range of fluctuation appearing in the measured value may be significant. While various types of liquid such as plant water and water for the other industrial purposes have recently been measured for water quality test, it is difficult to rely on stability as well as accuracy of measured values, depending on types of solution.

### SUMMARY OF THE INVENTION

In view of the problem as has been described above, it is an object of the present invention to provide an indicator electrode used for electrochemical measurement, for example, by the oxidation-reduction potentiometer and allowing such potentiometer to achieve accurate and stable measurement without regard of solution's types. Particularly, it is an important object of the present invention to provide an indicator electrode allowing accurate and stable measurement of potential not only for system solution containing oxidant as well as reductant at relatively high concentration (i.e., solution having high buffering capacity), but also even for system solution containing oxidant as well as reductant at relatively low concentration and solution of excessively high purity (i.e., solution having poor buffering capacity).

The object set forth above is achieved, according to one aspect of the present invention, by the indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 0.50 or less as measured in accordance with “Center line arithmetic average roughness Ra(μm)” specified by JIS B0601-1994.

The object set forth above is achieved, according to another aspect of the present invention, by the indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 1.70 or less as measured in accordance with “Maximum height Ry(μm)” specified by JIS B0601-1994.

The object set forth above is achieved, according to still another aspect of the present invention, by the indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 1.00 or less as measured in accordance with “Ten-point average roughness Rz (μm) specified by JIS B0601-1994.

The inventive indicator electrode having the surface roughness corresponding to or lower than at least one of the criteria specified by JIS B0601-1994 allows accurate and stable measurement of potential to be carried out not only for the system solution containing oxidant-reductant at relatively high concentration, for example, waste water but also for the system solution having excessively high purity, for example, bodily fluid such as human saliva and purified water.

### BRIEF DESCRIPTION OF THE DRAWINGS

FIG. 1 is a diagram schematically illustrating the oxidation-reduction potentiometer of prior art.

FIG. 2 is a graphic diagram showing measurement result obtained by using indicator electrodes each having surface roughness different from the others as measured on the basis of arithmetic average roughness Ra along center line and by using human saliva as sample solution.

FIG. 3 is a graphic diagram showing measurement result obtained by using indicator electrodes, each having surface roughness different from the others, as measured on the basis of arithmetic average roughness Ra along center line and by using purified water as sample solution.

FIG. 4 is a graphic diagram showing measurement result obtained by using indicator electrodes, each having surface roughness different from the others, as measured on the basis of arithmetic average roughness Ra along center line and by using KCl (1 mol) as sample solution.

FIG. 5 is a graphic diagram showing measurement result obtained by using indicator electrodes, each having surface roughness different from the others, as measured on the basis of arithmetic average roughness Ra along center line and by using Fe(CN)₆³⁻/Fe(CN)₆⁴⁻-based standard solution as sample solution.

FIG. 6 is a graphic diagram showing measurement result obtained by using indicator electrodes, each having surface roughness different from the others, as measured on the basis of the maximum height Ry and by using human saliva as sample solution.

FIG. 7 is a graphic diagram showing measurement result obtained by using indicator electrodes, each having surface roughness different from the others, as measured on the basis of the maximum height Ry and by using purified water as sample solution.

FIG. 8 is a graphic diagram showing measurement result obtained by using indicator electrodes, each having surface roughness different from the others, as measured on the basis of the maximum height Ry and by using KCL (1 mol) as sample solution.

FIG. 9 is a graphic diagram showing measurement result obtained by using indicator electrodes, each having surface roughness different from the others, as measured on the basis of the maximum height Ry and by using Fe(CN)₆³⁻/Fe(CN)₆⁴⁻ based standard solution as sample solution.

FIG. 10 is a graphic diagram showing measurement result obtained by using indicator electrodes, each having surface roughness different from the others, as measured on the basis of ten-point average roughness Rz and by using human saliva as sample solution.

FIG. 11 is a graphic diagram showing measurement result obtained by using indicator electrodes, each having surface roughness different from the others, as measured on the basis of ten-point average roughness Rz and by using purified water as sample solution.

FIG. 12 is a graphic diagram showing measurement result obtained by using indicator electrodes, each having surface roughness different from the others, as measured on the basis of ten-point average roughness Rz and by using KCl (1 mol) as sample solution.

FIG. 13 is a graphic diagram showing measurement result obtained by using indicator electrodes, each having surface roughness different from the others, as measured on the basis of ten-point average roughness Rz and by using Fe(CN)₆³⁻/Fe(CN)₆⁴⁻-based standard solution as sample solution.

FIG. 14 is a scale-enlarged front view of an embodiment of the indicator electrode.

FIG. 15 is a scale-enlarged a sectional view of another embodiment of the indicator electrode.

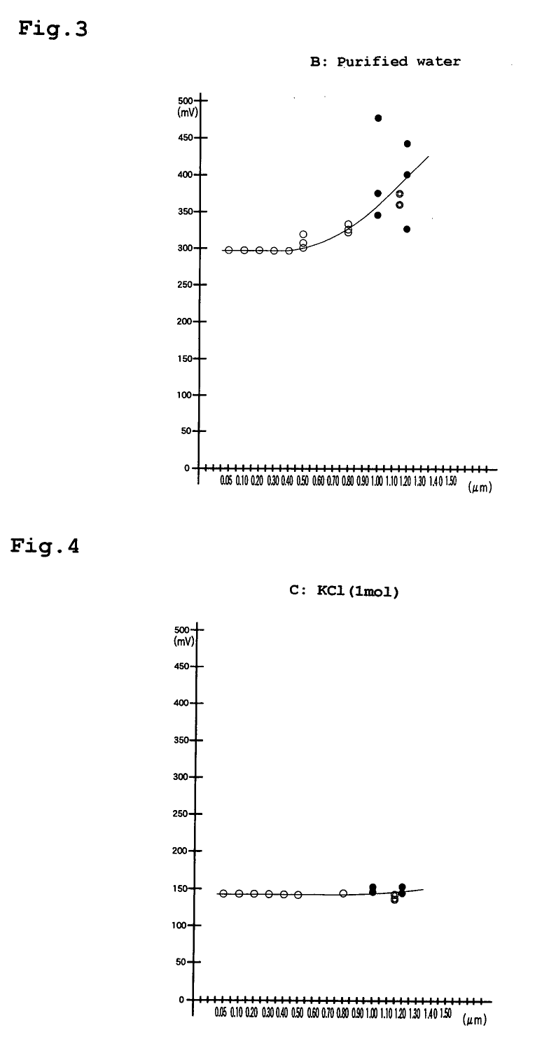

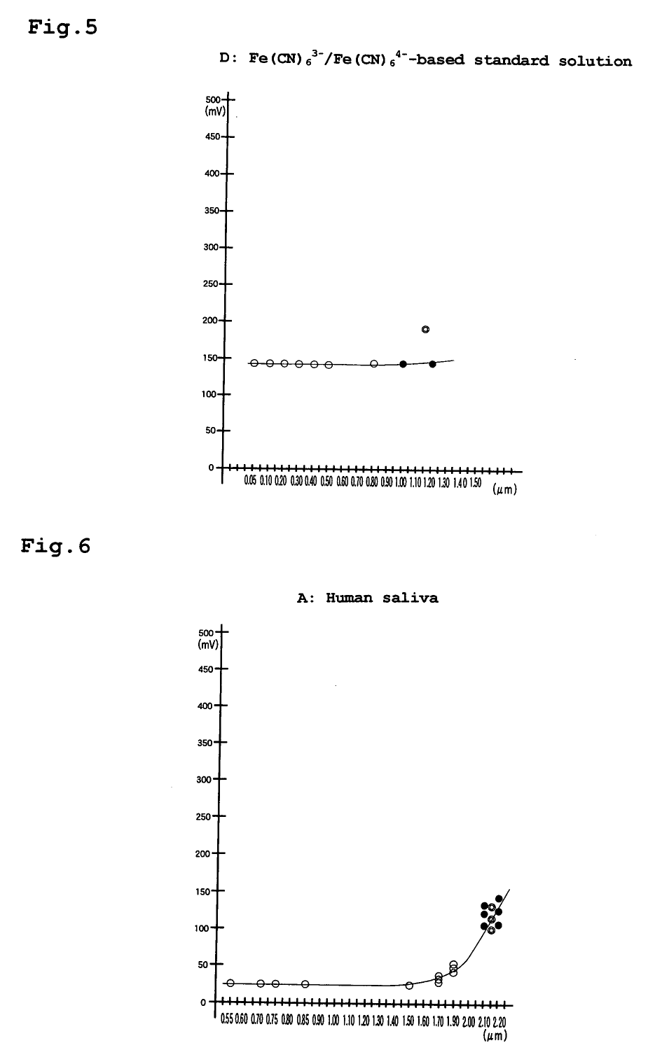

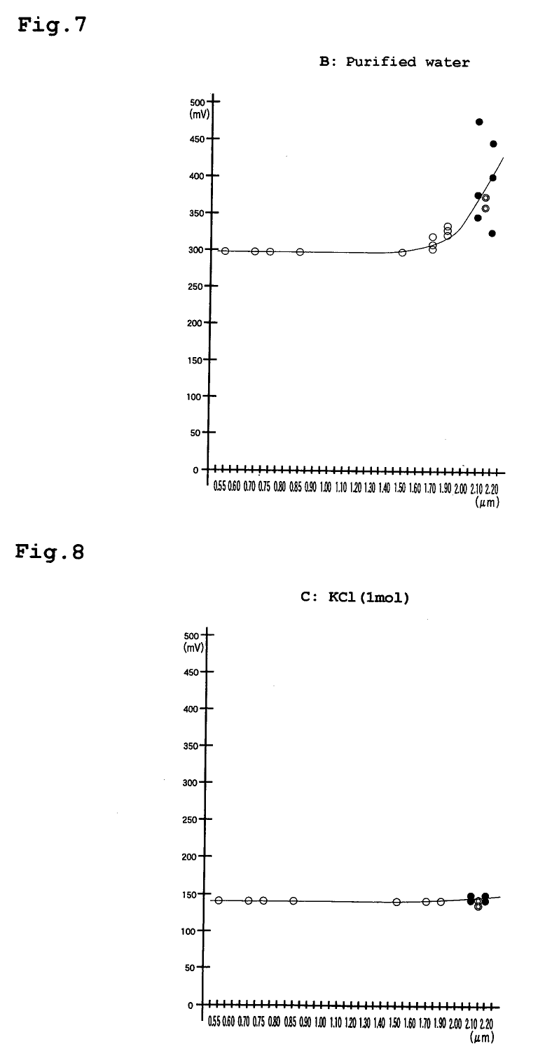

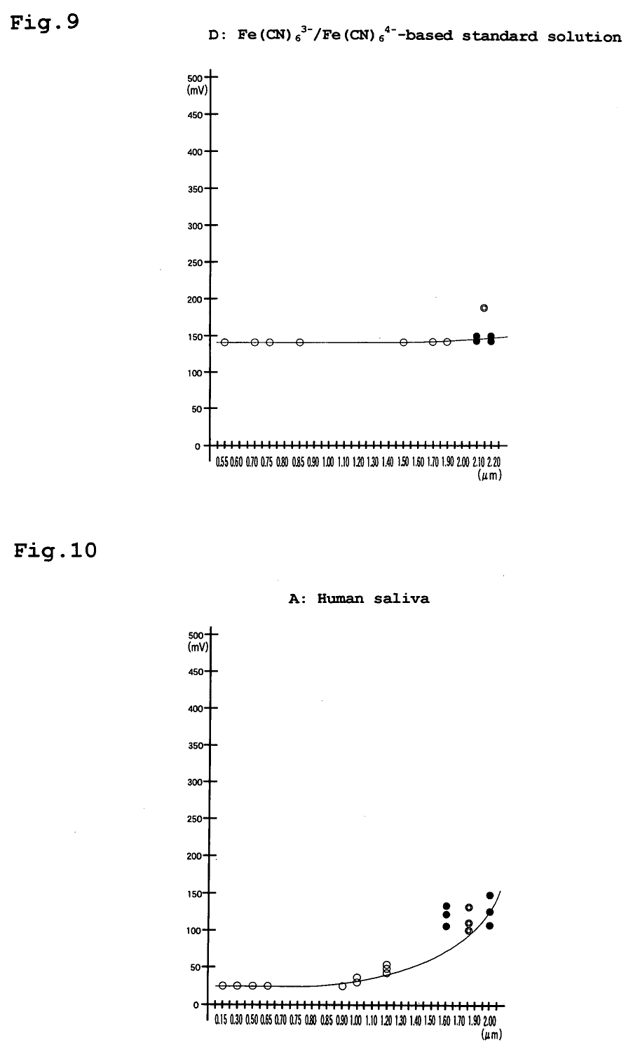

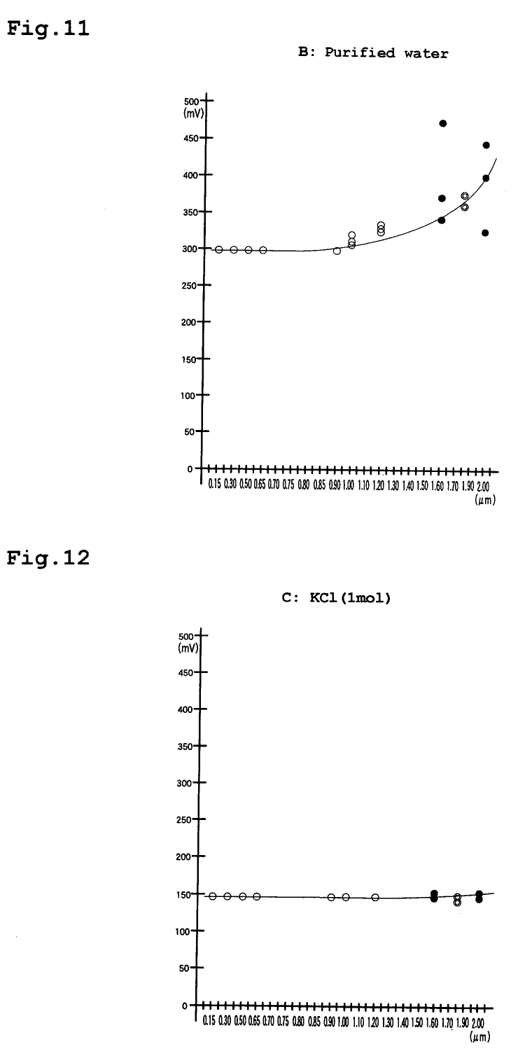

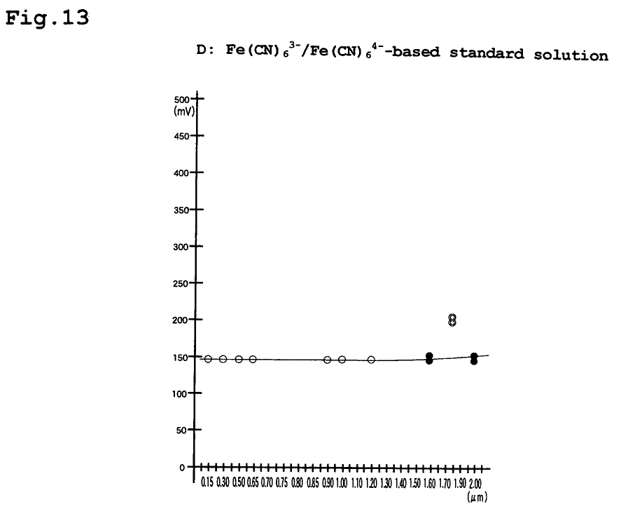

In the graphic diagrams illustrated by FIGS. 2 through 13, unit of potential on axis of ordinate is mV and unit of surface roughness on axis of abscissas is μm. A small open circle (◯) indicates the measured values obtained by using the inventive indicator electrode, a small filled circle (●) indicates the measured values obtained by using insufficiently polished indicator electrode and a small double circle (⊚) indicates the measured values obtained by using the conventional indicator electrodes.

### DETAILED DESCRIPTION OF THE INVENTION

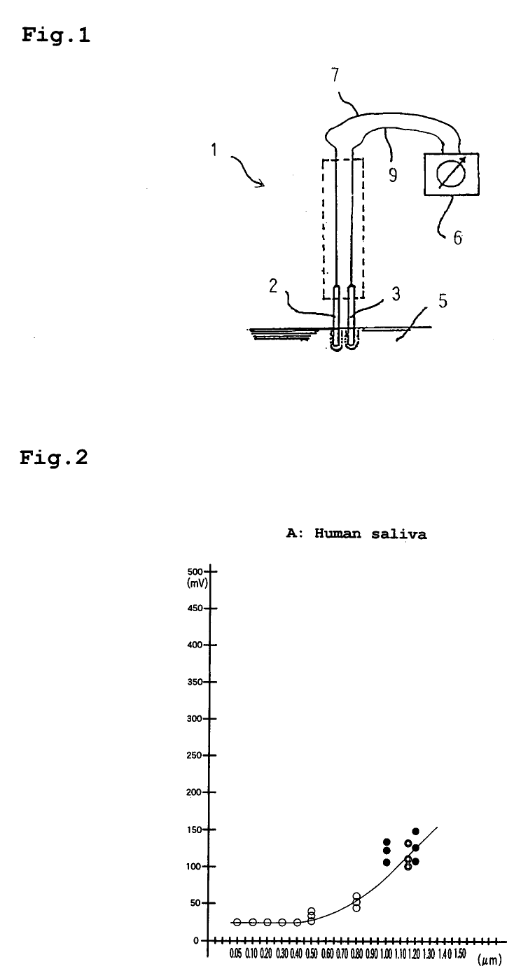

Details of the indicator electrode according to the present invention will be more fully understood from the description of the INVENTION given hereunder in reference with the accompanied drawings. As a typical example of the electrochemical measuring apparatus to be used for measurement of potential and current generated between the indicator electrode and the liquid, there has already been developed so-called oxidation-reduction potentiometer adapted to measure oxidation-reduction potential of solution. The present invention will be described hereunder on the basis of such oxidation-reduction potentiometer. As will be apparent from the schematic illustration in FIG. 1, the oxidation-reduction potentiometer 1 is provided with an indicator electrode 2 and a reference electrode 3. Both the electrodes 2, 3 are immersed in the solution so that the solution may come in contact with the surface of the indicator electrode 2 and thereby oxidation-reduction potential generated at interface between the indicator electrode 2 and the solution is measured. The indicator electrode 2 is made of electrically conductive material such as metal which is free from any affection by the solution. While inert metal such as platinum or gold are often used, the material for the indicator electrode 2 is not limited to them. The reference electrode 3 is usually made of metal such as silver or silver chloride.

It has been found from detailed examination of the conventional indicator electrode that the indicator electrode has on its surface countless of microscopic irregularities consisting of those which have already been present on the surface of the raw material before worked and those due to scorings generated in the course of manufacturing process. Some of them are visible by the naked eye, some of them are difficult to be recognized by the naked eye and some of them are impossible to be discovered by the naked eye. In the light of the result of various experiments and researches, the inventor reached a conclusion such that the surface roughness characteristic of the indicator electrode in the order of μm is closely related to stability and accuracy with which the potential can be measured. And it was confirmed that, particular when the concentration of oxidant-reductant contained in the system solution is relatively low or the system solution has excessively high purity, it depends on the surface roughness of the indicator electrode whether the potential measurement can be stably achieved or not. More specifically, if the surface of the indicator electrode with which the solution comes in contact has roughness due to irregularities or the like exceeds a predetermined criterion, the measured value of potential will fluctuate in a wide range, that is to say, the measurement of potential will be instable. If the surface of the indicator electrode has roughness corresponding to or lower than the predetermined criterion, on the contrary, the measurement of potential will be stabilized. This is for one of the reasons that excessive high surface roughness of the indicator electrode may generate local cells which prevent the potential measurement from being achieved with the desired high stability.

The indicator electrode according to the present invention should have its surface roughness characteristic regulated in a manner as will be described more in details. Specifically, the indicator electrode should have its surface roughness characteristic corresponding to or lower than at least one of the criteria specified by JIS B0601-1994, i.e., Center line arithmetic average roughness Ra(μm) of 0.50, Maximum height Ry(μm) of 1.70 and Ten-point average roughness Rz(μm) of 1.00 to ensure the potential measurement to be achieved with high stability. Further preferably, the indicator electrode should have its surface roughness characteristic corresponding to or lower than at least one of the criteria specified by JIS B0601-1994, i.e., Center line arithmetic average roughness Ra(μm) of 0.40, Maximum height Ry(μm) of 1.50 and Ten-point average roughness Rz(μm) of 0.90 to ensure the potential measurement to be achieved with higher stability. Not only for the solution system containing oxidant-reductant at a high concentration, i.e., for the solution system having a high buffering capacity, but also for the solution system having a poor buffering capacity, the potential measurement can be achieved at high accuracy and at high stability.

Center line arithmetic average roughness Ra, Maximum height Ry and Ten-point average roughness Rz (JIS B0601-1994) representing the surface roughness are defined as following. Center line arithmetic average roughness Ra is a value obtained by steps of cutting out the roughness curve by a predetermined length in a direction of the average line, summing up differential distance (absolute value) from the average line to the roughness curve in the cut out range and averaging the sum. Maximum height Ry is a value obtained by steps of cutting out the roughness curve by the predetermined length in the direction of the average line and summing up a height from the average line to the highest crest and a depth from the average line to the deepest valley floor in the cut out range. Ten-point average roughness Rz is a value obtained by steps of cutting out the roughness curve by the predetermined length in the direction of the average line, averaging absolute values of altitudes of five highest crests measured from the average line, averaging absolute values of depths of five deepest valley floors measured from the average line, and summing up these absolute values of the average values.

The surface roughness of the indicator electrode made, for example, of platinum or gold is regulated by precision polishing treatment. To regulate the indicator electrode to or lower than said criterion value of the surface roughness by using mechanical accurate polishing technique, the conventional technique such as lapping or polishing technique may be selectively used. The technique as well as the apparatus for polishing is not specified. For example, free abrasive grains each having a diameter in a range of 1 μm to several tens of μm is mixed with lubricant to prepare fine abrasive composition which is, in turn, supplied to a rotary table and applied against the indicator electrode (metal piece) so that a desired lapping treatment may be achieved by the relative movement of these three components.

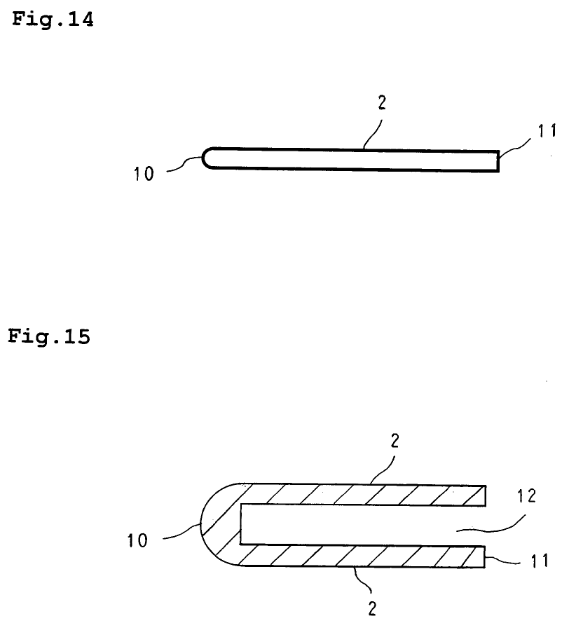

Shape of the indicator electrode may be optional, for example, may be of flap plate-shape or square bar-shape (not shown). The indicator electrodes 2 shown by FIGS. 14 and 15 are similar to each other in that the electrode is formed as a seamless round bar integrally with a round tip 10 and outer peripheral surface thereof including the tip 10 is polished. Proximal end 11 of the indicator electrode may be polished or not. Unique configuration of the indicator electrode 2 in the form of the seamless round bar integrally with the round tip 10 facilitates the outer peripheral surface to be evenly and accurately polished. The indicator electrode 2 shown by FIG. 15 is distinguished from the indicator electrode 2 shown by FIG. 4 in that this electrode 2 is bored with a cavity 12 extending in a longitudinal direction. Boring the cavity 12 in this manner is effect to reduce cost for valuable material such as platinum or gold. With the indicator electrode 2, i.e., with the polished outer peripheral surface thereof, the solution comes in contact. However, the solution does not come in contact with the cavity 12 and therefore it is unnecessary to polish the inner peripheral surface of the cavity 12.

Now the manner in which the indicator electrode disclosed in PATENT DOCUMENT (Japanese Laid-Open Patent Application Gazette No. 1999-118756) is polished will be discussed. While PATENT DOCUMENT described that the surface of the indicator electrode is polished, the purpose of this polishing is merely to initiate the surface of the indicator electrode in view of the fact that the surface of the indicator electrode may be coated with oxidized film as the potential measurement is repeated and the solution comes repeatedly in contact with the surface of the indicator electrode. In other words, such operation of polishing is merely to remove such coating of oxidized film and neither regulation of the surface roughness of the indicator electrode itself nor accurate polishing for this purpose is intended. On the contrary, the present invention intends to regulate the surface roughness of the indicator electrode in the order of μm level by accurate polishing and thereby to obtain the surface roughness corresponding to or lower than the predetermined criterion value. The potential measurement can be stably carried out first such accurate regulation of the surface roughness has been achieved. In this way, the present invention is distinguished from this prior art in the technical significance.

If any residual solution stays behind on the surface of the indicator electrode after potential measurement has been conducted for one type of solution, solution subjected to the next measurement may be contaminated with such residual solution of the previously used for potential measurement and prevented from being stably and reliably measured. Such risk of contamination is high particularly when the residual solution is of a high buffering capacity and solution to be measured thereafter is of a poor buffering capacity. To avoid such apprehension, the indicator electrode is preferably carefully washed until the residual solution is removed as completely as possible before the potential measurement of the next solution is started. According to the present invention, the surface roughness of the indicator electrode at least corresponds to the predetermined criterion value and any residual solution staying behind the surface of the indicator electrode can be reliably removed. In this way, instability of the potential measurement due to the residual solution staying behind on the surface can be reliably avoided. Purified water (i.e., pure water) is sufficiently useful to remove the residual solution and it is unnecessary to use any detergent usually used for such purpose.

The residual solution, if staying behind, a degree of contamination by such residual solution is relatively minor in the case of potential measurement for the solution of high buffering capacity such as waste water. And it is usually not apprehended that the potential measurement of the solution such as waste water might become instable.

The indicator electrode having the surface roughness corresponding to or lower than at least one of the predetermined criteria allows accurate and stable measurement of potential to be carried out not only for the system solution containing oxidant-reductant at relatively high concentration, for example, waste water but also for the system solution having excessively high purity, for example, bodily fluid such as human saliva, blood and urine, drinkable water and purified water (pure water).

Example

Embodiments according to the present invention will be described herein after in comparison with controls. In the embodiments and the controls, the indicator electrode is made of platinum in the form of a round bar having a round tip but having no cavity therein (See FIG. 14). The indicator electrode has a length of 40 mm and a diameter of 2 mm. The indicator electrodes (4) through (9) have surfaces accurately polished by lapping treatment. Specifically, free abrasive grains each having a diameter in a range of 1 μm to several tens of μm is mixed with lubricant to prepare fine abrasive composition which is, in turn, supplied to a rotary table and applied against the indicator electrode so that a desired lapping treatment may be achieved by the relative movement of these three components. As abrasive cloth for finishing, “Shinju-Teri-Cloth” (manufactured by Shinju Kagaku Kenkyuhsho) was used. The indicator electrodes (1) through (9) respectively had degrees of surface roughness different one from another as measured on the basis of Center line arithmetic average roughness Ra(μm), Maximum height Ry(μm) and Ten-point average roughness Rz(μm) (all of which are specified by JIS B0601-1994). Of the controls (i.e., the indicator electrodes (1) through (3), the indicator electrode (1) was not polished and the indicator electrodes (2), (3) were insufficiently polished. The reference electrodes were of silver-silver chloride electrodes.

Four sample solutions were used: (A) human saliva, (B) purified water (pure water), (C) KCl(1 mol), (D) Fe(CN)₆³⁻/Fe(CN)₆⁴⁻-based standard solution. The sample solutions (A) and (B) were those having poor buffering capacity and the sample solutions (C) and (D) were those having high buffering capacity. These sample solutions were put in the respective surfaces of the indicator electrodes (1) through (9) and oxidation-reduction potential (mV) for these sample solutions were measured. Measurement was carried out three times for one and same sample solution. For measurement of oxidation-reduction potential, the commercially available (conventional type) oxidation-reduction potentiometer was incorporated with the indicator electrodes (1) through (9) and the stability of measurement was confirmed.

TABLE 1

| type of | | | oxidation-reduction of sample solution(mV) | | | |
|---|---|---|---|---|---|---|
| indicator | surface | times of | A: human | B: purified | C: KCl | D: Fe(CN)₆³⁻/Fe(CN)₆⁴⁻- |
| electrode | roughness | measurement | saliva | water | (1 mol) | based standard solution |
| type (1) | Ra(μm)1.20 | 1 | 109 | 327 | 143 | 140 |
| | Ry(μm)2.20 | 2 | 143 | 401 | 141 | 141 |
| | Rz(μm)2.00 | 3 | 124 | 443 | 142 | 142 |
| type (2) | Ra(μm)1.00 | 1 | 134 | 343 | 141 | 141 |
| | Ry(μm)2.10 | 2 | 121 | 474 | 142 | 141 |
| | Rz(μm)1.60 | 3 | 109 | 376 | 144 | 142 |
| type (3) | Ra(μm)0.80 | 1 | 55 | 332 | 141 | 140 |
| | Ry(μm)1.90 | 2 | 48 | 329 | 140 | 141 |
| | Rz(μm)1.20 | 3 | 44 | 324 | 140 | 141 |
| type (4) | Ra(μm)0.50 | 1 | 38 | 320 | 139 | 140 |
| | Ry(μm)1.70 | 2 | 33 | 307 | 140 | 141 |
| | Rz(μm)1.00 | 3 | 30 | 305 | 139 | 141 |
| type (5) | Ra(μm)0.40 | 1 | 24 | 297 | 138 | 139 |
| | Ry(μm)1.50 | 2 | 26 | 298 | 139 | 140 |
| | Rz(μm)0.90 | 3 | 26 | 300 | 139 | 140 |
| type (6) | Ra(μm)0.30 | 1 | 25 | 298 | 139 | 139 |
| | Ry(μm)0.85 | 2 | 26 | 299 | 139 | 140 |
| | Rz(μm)0.65 | 3 | 26 | 300 | 140 | 141 |
| type (7) | Ra(μm)0.20 | 1 | 24 | 297 | 138 | 138 |
| | Ry(μm)0.75 | 2 | 26 | 298 | 139 | 139 |
| | Rz(μm)0.50 | 3 | 26 | 300 | 140 | 139 |
| type (8) | Ra(μm)0.10 | 1 | 25 | 298 | 139 | 138 |
| | Ry(μm)0.70 | 2 | 26 | 299 | 139 | 139 |
| | Rz(μm)0.30 | 3 | 26 | 300 | 140 | 140 |
| type (9) | Ra(μm)0.05 | 1 | 25 | 298 | 139 | 138 |
| | Ry(μm)0.55 | 2 | 26 | 299 | 139 | 139 |
| | Rz(μm)0.15 | 3 | 26 | 300 | 140 | 140 |

Regarding the sample solutions (C) and (D) having high buffering capacity, TABLE 1 and the graphic diagrams illustrated by FIGS. 2 through 13 indicate that the measured values obtained by using the indicator electrodes (4) through (9) according to the present invention are substantially same as those obtained using the indicator electrodes (1) through (3) as CONTROLS and basically correspond to each other. It means that the stabilized measurement of potential is ensured regardless of the factors such as the surface roughness of the indicator electrode, i.e., whether the electrode was subjected to polishing treatment or not and the degree of polishing, so far as the solution having high buffering capacity is concerned. In the case of the sample solutions (A) and (B) having poor buffering capacity, on the other hand, the measured values obtained by using the indicator electrodes (1) through (3) as CONTROLS fluctuate in a considerably wide range. Range in which these measured values fluctuate is too wide to achieve stabilized measurement of potential. Such result of measurement well supports the previous description concerning the drawbacks of the conventional indicator electrode. In the graphic diagrams illustrated by FIGS. 2 through 13, a small open circle (◯) indicates the measured values obtained by using the inventive indicator electrode, a small filled circle (●) indicates the measured values obtained by using insufficiently polished indicator electrode and a small double circle (⊚) indicates the measured values obtained by using the conventional indicator electrodes.

The indicator electrodes (4) through (9) according to the embodiments of this invention unexceptionally achieve stabilized measurement of potential for every sample solution. When Center line arithmetic average roughness Ra(μm) of 0.50, Maximum height Ry(μm) of 1.70 and Ten-point average roughness Rz(μm) of 1.00 are specified as criteria, the indicator electrodes (4) through (9) presenting any one of Ra, Ry and Rz which corresponds to or lower than the above-indicated value can achieve the stabilized measurement of potential. More preferably, the indicator electrodes (5) through (9) presenting any one of Ra, Ry and Rz which corresponds to or lower than more strict criteria, for example, Ra(μm) of 0.40, Ry(μm) of 1.50 and Rz(μm) Of 0.90 can achieve further stabilized measurement of potential. On the other hand, the indicator electrodes (1) through (3) according to CONTROLS cannot achieve stabilized measurement of potential for the sample solutions having poor buffering capacity. In this manner, the potential measurement by the indicator electrodes according to the invention is effective, accurate and stable even for the solution having poor buffering capacity.

Graphic diagrams illustrated by FIGS. 2 through 5 indicate result of potential measurement for the sample solutions (A), (B), (C) and (D) obtained by using the indicator electrodes which are different one from another in Center line arithmetic average roughness Ra (unit of potential on axis of ordinate is mV and unit of surface roughness on axis of abscissas is μm). As will be seen in these graphic diagrams, the indicator electrode polished to Center line arithmetic average roughness Ra(μm) of 0.50 or lower achieved stabilized measurement of potential for 4 types of sample solutions. The indicator electrode polished to Center line arithmetic average roughness Ra(μm) of 0.40 or lower achieved further stabilized measurement of potential for 4 types of sample solutions. The insufficiently polished indicator electrode having its Center line arithmetic average roughness Ra(μm) exceeding 0.50 achieved stabilized measurement of potential for the insufficiently polished sample solutions (C) and (D) but not for the sample solutions (A) and (B).

Graphic diagrams illustrated by FIGS. 6 through 9 indicate result of potential measurement for the sample solutions (A), (B), (C) and (D) obtained by using the indicator electrodes which are different one from another in Maximum height Ry. As will be seen in these graphic diagrams, the indicator electrode polished to Maximum height Ry(μm) of 1.70 or lower achieved stabilized measurement of potential for 4 types of sample solutions. The indicator electrode polished to Maximum height Ry(μm) of 1.50 or lower achieved further stabilized measurement of potential for 4 types of sample solutions. The insufficiently polished indicator electrode having its Maximum height Ry (μm) exceeding 1.70 achieved stabilized measurement of potential for the insufficiently polished sample solutions (C) and (D) but not for the sample solutions (A) and (B).

Graphic diagrams illustrated by FIGS. 10 through 13 indicate result of potential measurement for the sample solutions (A), (B), (C) and (D) obtained by using the indicator electrodes which are different one from another in Ten-point average roughness Rz. As will be seen in these graphic diagrams, the indicator electrode polished to Ten-point average roughness Rz(μm) of 1.00 or lower achieved stabilized measurement of potential for 4 types of sample solutions. The indicator electrode polished to Ten-point average roughness Rz(μm) of 0.90 or lower achieved further stabilized measurement of potential for 4 types of sample solutions. The insufficiently polished indicator electrode having its Ten-point average roughness Rz(μm) exceeding 1.00 achieved stabilized measurement of potential for the sample solutions (C) and (D) but not for the insufficiently polished sample solutions (A) and (B).

In the case of the conventional oxidation-reduction potentiometer, for example, having a measuring range of −1500 mV to +1500 mV or of −1999 mV to +1999 mV, allowable limits in a range of 0.2 to 0.5% have usually been given for a reproducible measurement accuracy. In other words, a measurement error in a range of 60 mV to 150 mV is allowable in the former case while a measurement error in a range of 79 mV to 199 mV is allowable in the latter case. In the case of the indicator electrode according to the invention, a reproducible measurement accuracy of 15 mV or lower was achieved even for human saliva having poor buffering capacity. As a further preferable result, a reproducible measurement accuracy of 5 mV or lower was achieved by the indicator electrode according to the invention. The similar result was obtained by the indicator electrode bored with the cavity 12 (See FIG. 15). It has been also found that higher the purity of platinum is, more accurately and more stably the potential can be measured.

As will be apparent from the foregoing description, the indicator electrode according to the invention ensures the improved accuracy of measurement as well as the accurate and stable measurement of potential even for the solution having relatively poor buffering capacity. From this viewpoint, the present invention enables human saliva to be measured thereby to determine a condition of oxidant-reductant in human body and to contribute to health control. In this way, the indicator electrode according to the invention may find a range of industrial application.

1. Indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 0.50 or less as measured in accordance with “Center line arithmetic average roughness Ra (μm)” specified by JIS B0601-1994.

2. Indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 1.70 or less as measured in accordance with “Maximum height Ry (μm)” specified by JIS B0601-1994.

3. Indicator electrode made of electrically conductive material such as metal provided in an electrochemical measuring apparatus for liquid so as to be used for measurement of potential and current generated between the indicator electrode and the liquid, wherein a surface of the indicator electrode is polished until a surface roughness characteristic of the indicator electrode becomes 1.00 or less as measured in accordance with “Ten-point average roughness Rz (μm)” specified by JIS B0601-1994.

4. The indicator electrode as defined by claim 1, wherein the surface of the indicator electrode is polished and formed as a seamless round bar integrally with a round tip.

5. The indicator electrode as defined by claim 1, wherein the surface of the indicator electrode is polished and formed as a seamless round bar integrally with a round tip and having a cavity bored in a longitudinal direction.

6. The indicator electrode as defined by claim 2, wherein the surface of the indicator electrode is polished and formed as a seamless round bar integrally with a round tip.

7. The indicator electrode as defined by claim 3, wherein the surface of the indicator electrode is polished and formed as a seamless round bar integrally with a round tip.

8. The indicator electrode as defined by claim 2, wherein the surface of the indicator electrode is polished and formed as a seamless round bar integrally with a round tip and having a cavity bored in a longitudinal direction.

9. The indicator electrode as defined by claim 3, wherein the surface of the indicator electrode is polished and formed as a seamless round bar integrally with a round tip and having a cavity bored in a longitudinal direction.
